(19) United States
(12) Patent Application Publication
(10) Pub. No.: US 2026/0264502 A1
(43) Pub. Date: Sep. 10, 2026

(54) MOUNTING STRUCTURE FOR VEHICLE ON-BOARD DEVICE

(71) Applicant: TOYOTA JIDOSHA KABUSHIKI KAISHA, Toyota-shi (JP)

(72) Inventor: Koichi NAKAMURA, Miyoshi-shi (JP)

(21) Appl. No.: 19/372,310

(22) Filed: Oct. 29, 2025

(30) Foreign Application Priority Data
Mar. 10, 2025 (JP) 2025-037394

(51) Int. Cl. B60K 6/40; B60K 6/28; B60K 11/04; B60L 50/60; B60L 53/22

(52) U.S. Cl. CPC B60K 6/40; B60K 6/28; B60K 11/04; B60L 50/60; B60L 53/22; B60L 2210/30

(57) ABSTRACT

A mounting structure for a vehicle on-board device is provided. The mounting structure includes a floor panel that forms a floor surface of a passenger compartment of an electric vehicle, an integrated electromechanical unit as a vehicle on-board device mounted on the electric vehicle, and a vehicle on-board charger that charges a battery cell of the electric vehicle by converting AC power supplied from outside into DC power. The integrated electromechanical unit includes a motor that is a power source of the electric vehicle, and a power transmission mechanism that transmits a driving force of the motor to a drive wheel of the electric vehicle. The vehicle on-board charger is disposed above the floor panel. The integrated electromechanical unit is disposed under the floor panel.

### CROSS-REFERENCE TO RELATED APPLICATIONS

This application is based upon and claims the benefit of priority from Japanese Patent Application No. 2025-037394, filed on March 10, 2025, the entire contents of which are incorporated herein by reference.

### BACKGROUND

### 1. Field

This disclosure relates to a mounting structure for a vehicle on-board device.

### 2. Description of Related Art

JP2012-144227A discloses a motor case for an electric vehicle. The motor case houses a traction motor and a differential gear. A power control unit case is disposed above the motor case. The power control unit case controls the traction motor. The differential gear is a power transmission mechanism that transmits rotational driving force from the motor to the drive wheels. The motor case is a so-called integrated electromechanical unit, in which the traction motor and the power transmission mechanism are integrated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a mounting structure for a vehicle on-board device is provided. The mounting structure includes a floor panel that forms a floor surface of a passenger compartment of an electric vehicle, an integrated electromechanical unit as a vehicle on-board device mounted on the electric vehicle, and a vehicle on-board charger that charges a battery cell of the electric vehicle by converting AC power supplied from outside into DC power. The integrated electromechanical unit includes a motor that is a power source of the electric vehicle, and a power transmission mechanism that transmits a driving force of the motor to a drive wheel of the electric vehicle. The vehicle on-board charger is disposed above the floor panel. The integrated electromechanical unit is disposed under the floor panel.

The above-described mounting structure for the vehicle on-board device reduces the influence of vibrations generated in the integrated electromechanical unit on the vehicle on-board charger.

Some electric vehicles are equipped with a vehicle on-board charger having the following configuration. For example, the vehicle on-board charger converts AC power supplied from an external source into DC power to charge battery cells. Vibrations generated by the integrated electromechanical unit may potentially affect the vehicle on-board charger. The above-described configuration suppresses this potential issue.

Other features and aspects will be apparent from the following detailed description, the drawings, and the claims.

### BRIEF DESCRIPTION OF THE DRAWINGS

FIG. 1 is a schematic diagram showing a mounting structure for a vehicle on-board device in an electric vehicle according to an embodiment, as viewed from the side of the vehicle.

FIG. 2 is a schematic diagram showing a configuration of a drivetrain and an electrical system of the electric vehicle shown in FIG. 1.

FIG. 3 is a schematic diagram showing how of the cooling pipes shown in FIG. 2 are routed.

FIG. 4 is a schematic diagram illustrating the mounting structure for the vehicle on-board device, showing the vehicle on-board charger of FIG. 3 as viewed from above the vehicle.

FIG. 5 is a schematic diagram showing how of cooling pipes of a comparative example are routed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

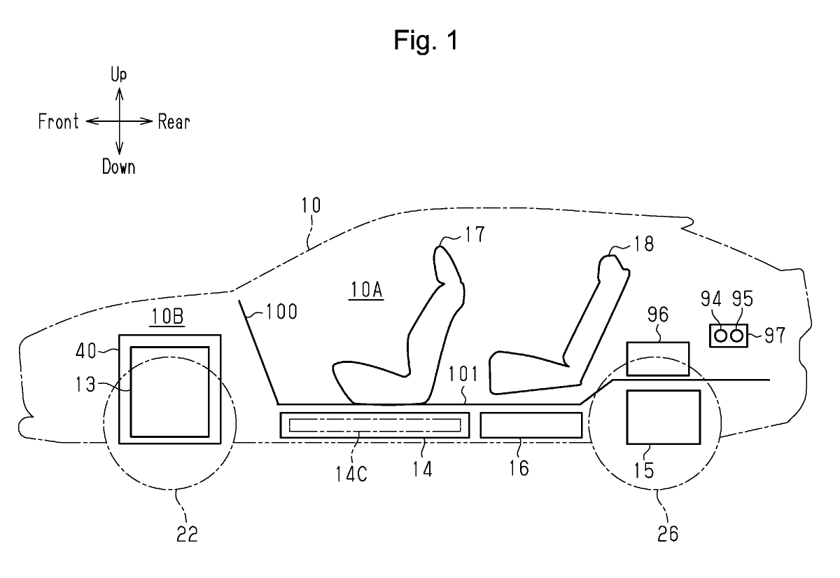

A mounting structure for a vehicle on-board device according to an embodiment will now be described with reference to FIGS. 1 to 4. In the following description, the terms front, rear, left, right, up, and down refer to directions as viewed from the perspective of an occupant in an electric vehicle facing forward. The left-right direction corresponds to the vehicle width direction.

The vehicle front-rear direction and the vehicle vertical direction are directions relating to each of the vehicle on-board devices in a state in which each of the vehicle on-board devices is mounted on the electric vehicle. The vehicle front-rear direction is a front-rear direction of the electric vehicle. The vehicle vertical direction is a direction of a vertical line, that is, a height direction. Viewing in the vehicle vertical direction means viewing from above to below or from below to above in the vehicle vertical direction.

### Layout of Electric Vehicle 10

FIG. 1 schematically shows an internal structure of an electric vehicle 10 in a vehicle side view in which the electric vehicle 10 is viewed from the left side.

As shown in FIG. 1, the electric vehicle 10 has a total of four wheels including left and right front wheels 22 and left and right rear wheels 26. Inside the electric vehicle 10, two compartments, that is, a passenger compartment 10A and a front compartment 10B are provided. The front compartment 10B is located forward of the passenger compartment 10A in the vehicle.

The electric vehicle 10 includes a dashboard panel 100 and a floor panel 101. The dashboard panel 100 separates the passenger compartment 10A from the front compartment 10B. The floor panel 101 constitutes a floor surface of a passenger compartment 10A of the electric vehicle 10.

The engine 40 and the first integrated electromechanical unit 13 are disposed in the front compartment 10B. The engine 40 is one of power sources of the electric vehicle 10. The first integrated electromechanical unit 13 will be described later.

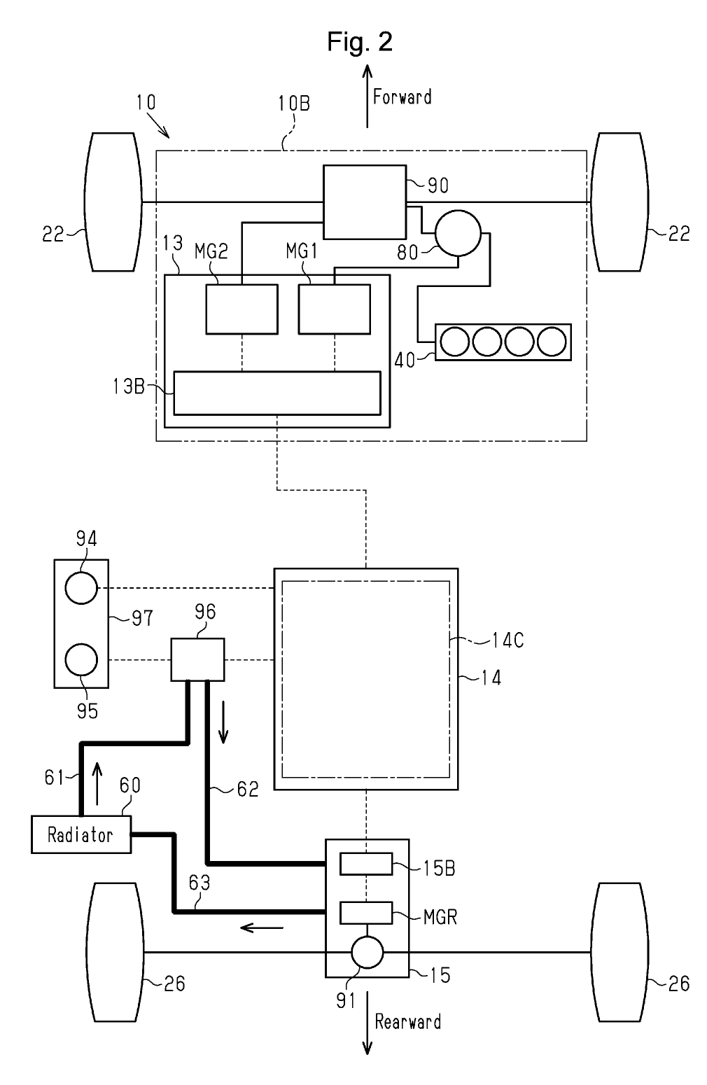

The electric vehicle 10 includes a battery pack 14. The battery pack 14 is disposed under the floor panel 101. The battery pack 14 accommodates multiple battery cells 14C therein. In FIGS. 1 and 2, the battery cells 14C, which are tightly packed within the battery pack 14, are collectively depicted surrounded by a long-dash short-dash line. The battery cells 14C store electric power to be supplied to a first motor-generator MG1, a second motor-generator MG2, and a rear-wheel driving motor-generator MGR, which are described below.

The electric vehicle 10 includes a fuel tank 16. The fuel tank 16 is disposed rearward of the battery pack 14 and under the floor panel 101. The fuel tank 16 stores fuel to be supplied to the engine 40.

Two rows of seats, i.e., front row seats 17 and rear row seats 18, are disposed in the passenger compartment 10A. The front row seats 17 include a driver's seat.

The electric vehicle 10 includes a vehicle on-board charger 96. The vehicle on-board charger 96 is disposed in the passenger compartment 10A. The vehicle on-board charger 96 is disposed on the floor panel 101. The vehicle on-board charger 96 is disposed rearward of the front row seats 17 and the rear row seats 18 in the vehicle. The vehicle on-board charger 96 converts AC power supplied from an external source into DC power to charge the battery cells 14C.

The electric vehicle 10 includes a second integrated electromechanical unit 15. The second integrated electromechanical unit 15 is disposed under the floor panel 101. The second integrated electromechanical unit 15 will be described later.

### Drivetrain and Electrical System of the Electric Vehicle 10

FIG. 2 schematically shows a configuration of a drivetrain and a configuration of an electrical system of the electric vehicle 10. The broken lines shown in FIG. 2 indicate electrical connections between devices.

As shown in FIG. 2, the electric vehicle 10 includes an engine 40, a first integrated electromechanical unit 13, a power split mechanism 80, and a speed reduction mechanism 90 in the front compartment 10B. The first integrated electromechanical unit 13 is a unit in which the first motor-generator MG1, the second motor-generator MG2, and a first electric power controller 13B are integrated.

The engine 40 is coupled to the left and right front wheels 22 via the power split mechanism 80 and the speed reduction mechanism 90. The power split mechanism 80 is a planetary gear mechanism. The power split mechanism 80 can split the driving force among the engine 40, the first motor-generator MG1, and the left and right front wheels 22. The power split mechanism 80 and the speed reduction mechanism 90 constitute a part of a power transmission mechanism. The rotational power of the engine 40 is transmitted to the front wheels 22 via the power transmission mechanisms. That is, the engine 40 is a power source of the electric vehicle 10.

The first motor-generator MG1 is coupled to the power split mechanism 80. The first motor-generator MG1 is, for example, a three-phase AC motor-generator. The first motor-generator MG1 is electrically connected to the battery pack 14 via the first electric power controller 13B. The second motor-generator MG2 is coupled to the left and right front wheels 22 via the speed reduction mechanism 90. The second motor-generator MG2 is, for example, a three-phase AC motor-generator. The second motor-generator MG2 is electrically connected to the battery pack 14 via the first electric power controller 13B. That is, the first electric power controller 13B is electrically connected to the battery pack 14.

The first motor-generator MG1 functions as an electric motor that generates rotational driving force in response to supply of electric power from the first electric power controller 13B. The rotational driving force of the first motor-generator MG1 is transmitted to the left and right front wheels 22 via the power split mechanism 80 and the speed reduction mechanism 90. The first motor-generator MG1 also serves as a stator that drives the crankshaft when the engine 40 is started. The crankshaft is an output shaft of the engine 40.

The second motor-generator MG2 functions as another motor that generates rotational power in response to the supply of electric power from the first electric power controller 13B. The rotational driving force of the second motor-generator MG2 is transmitted to the left and right front wheels 22 via the speed reduction mechanism 90.

The first motor-generator MG1 generates electric power by receiving the driving force of the engine 40 and the driving force from the front wheels 22. The AC power generated by the first motor-generator MG1 is converted into DC power by the first electric power controller 13B. Thereafter, the DC power converted by the first electric power controller 13B is charged in the battery cells 14C. That is, the first electric power controller 13B functions as an invertor. The first electric power controller 13B may have a function as a converter that boosts the electric power supplied from the battery cells 14C.

DC power is supplied from the battery cells 14C to the first electric power controller 13B. The supplied DC power is converted into AC power by the first electric power controller 13B. The AC power converted by the first electric power controller 13B is supplied to the second motor-generator MG2. When the electric vehicle 10 is decelerated, the second motor-generator MG2 generates electric power using the driving force from the front wheels 22. The generated electric power is charged in the battery cells 14C. That is, the electric vehicle 10 performs regenerative charging. At this time, the second motor-generator MG2 functions as a power generator. The AC power generated by the second motor-generator MG2 is converted into DC power by the first electric power controller 13B. The DC power converted by the first electric power controller 13B is charged in the battery cells 14C.

### Second Integrated Electromechanical Unit 15

As shown in FIG. 2, the electric vehicle 10 includes a second integrated electromechanical unit 15 located rearward of the battery pack 14. The second integrated electromechanical unit 15 is a unit in which the rear-wheel driving motor-generator MGR, a second electric power controller 15B, and a differential device 91 are integrated.

The rear-wheel driving motor-generator MGR is coupled to the left and right rear wheels 26 via a differential device 91. The rear-wheel driving motor-generator MGR is, for example, a three-phase AC motor-generator. The rear-wheel driving motor-generator MGR is electrically connected to the battery pack 14 via the second electric power controller 15B. The rear-wheel driving motor-generator MGR is electrically connected to the second electric power controller 15B.

The rear-wheel driving motor-generator MGR functions as a motor that generates rotational power in response to supply of electric power from the second electric power controller 15B. That is, the second electric power controller 15B drives the rear-wheel driving motor-generator MGR. The rotational power of the rear-wheel driving motor-generator MGR is transmitted to the left and right rear wheels 26 via a differential device 91. That is, the rear-wheel driving motor-generator MGR functions as a motor constituting a power source of the electric vehicle 10. The differential device 91 functions as a power transmission mechanism that transmits the driving force of the motor to the rear wheels 26 as drive wheels. The power transmission mechanism included in the second integrated electromechanical unit 15 is not limited to the differential device 91. Any of multiple mechanisms that transmit the rotational power of the rear-wheel driving motor-generator MGR to the rear wheel 26 can constitute a power transmission mechanism.

When the electric vehicle 10 is decelerated, the rear-wheel driving motor-generator MGR generates electric power using the driving force from the left and right rear wheels 26. The generated electric power is charged in the battery cells 14C. That is, the electric vehicle 10 performs regenerative charging. At this time, the rear-wheel driving motor-generator MGR functions as a generator. The AC power generated by the rear-wheel driving motor-generator MGR is converted into DC power by the second electric power controller 15B. The DC power converted by the second electric power controller 15B is charged in the battery cells 14C. That is, the second electric power controller 15B functions as an invertor. The second electric power controller 15B may function as a converter that boosts the electric power supplied from the battery cells 14C.

### Electrical System Associated with Vehicle On-Board Charger 96

As shown in FIGS. 1 and 2, the electric vehicle 10 includes a charging port 97. The charging port 97 is connectable to an external power supply in order to charge the battery cells 14C with electric power supplied from the external power supply. That is, the electric vehicle 10 is a plug-in hybrid vehicle.

The charging port 97 is provided with a first charging port 94 and a second charging port 95 as charging inlets for connecting a connector of an external power supply. The first charging port 94 is a charging inlet used for fast charging with a high-voltage DC power supply, such as 50 kW. The second charging port 95 is a charging inlet used for normal charging performed using an AC power supply such as a 100V or a 200V. When a connector of an external power supply is connected to the charging inlet, the electric vehicle 10 is connected to the external power supply.

As shown in FIG. 2, the first charging port 94 is electrically connected to the battery pack 14. A DC power supply is connected to the first charging port 94. The DC power input from the DC power source connected to the first charging port 94 is supplied to the battery cells 14C. The second charging port 95 is electrically connected to the vehicle on-board charger 96. The vehicle on-board charger 96 is electrically connected to the battery pack 14. The vehicle on-board charger 96 converts AC power input from the AC power source connected to the second charging port 95 into DC power, and then outputs the DC power to the battery cells 14C to charge the battery cells 14C.

As shown in FIG. 2, the electric vehicle 10 includes a radiator 60. The radiator 60 is a heat exchanger for cooling the coolant by heat exchange with outside air. Specifically, the radiator 60 cools coolant that recovers heat generated from the vehicle on-board charger 96 and heat generated from the second integrated electromechanical unit 15. The electric vehicle 10 includes a first cooling pipe 61, a second cooling pipe 62, and a third cooling pipe 63 as cooling pipes through which the coolant flows.

### Mounting Structure for the Vehicle On-board Charger 96 and the Second Integrated Electromechanical Unit 15

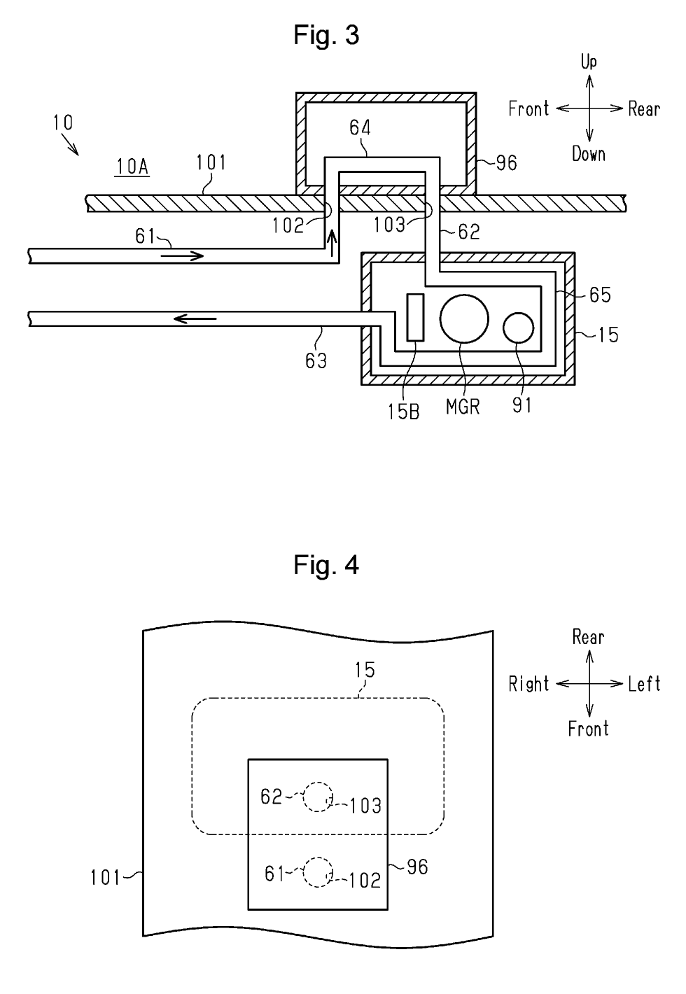

As shown in FIG. 3, the vehicle on-board charger 96 includes a first water jacket 64 through which coolant flows. That is, the vehicle on-board charger 96 is cooled by the coolant flowing in the first water jacket 64. The second integrated electromechanical unit 15 includes a second water jacket 65 through which the coolant flows. That is, the second integrated electromechanical unit 15 is cooled by the coolant flowing in the second water jacket 65.

As shown in FIGS. 2 and 3, the first cooling pipe 61 connects the radiator 60 to the first water jacket 64. The second cooling pipe 62 connects the first water jacket 64 to the second water jacket 65. The third cooling pipe 63 connects the second water jacket 65 to the radiator 60.

In FIGS. 2 and 3, the flow direction of the coolant is indicated by arrows. That is, the coolant flows through the radiator 60, the first cooling pipe 61, the first water jacket 64, the second cooling pipe 62, the second water jacket 65, and the third cooling pipe 63 in this order. In the reverse order, the coolant may be designed to flow through the radiator 60, the third cooling pipe 63, the second water jacket 65, the second cooling pipe 62, the first water jacket 64, and the first cooling pipe 61 in this order.

The floor panel 101 has a first floor through-hole 102 and a second floor through-hole 103. The first floor through-hole 102 extends in the vehicle vertical direction. The second floor through-hole 103 also extends in the vehicle vertical direction.

The first cooling pipe 61 is inserted into the first floor through-hole 102. The second cooling pipe 62 is inserted through the second floor through-hole 103. That is, a cooling pipe that connects the first water jacket 64 to the second water jacket 65 is inserted through the second floor through-hole 103.

FIG. 4 is a schematic view of the vehicle on-board charger 96 as viewed from above.

As shown in FIG. 4, the vehicle on-board charger 96, the second floor through-hole 103, and the second integrated electromechanical unit 15 at least partially overlap each other when viewed in the vehicle vertical direction. In particular, the entire second floor through-hole 103 is included in the overlap region.

### Operation of the Present Embodiment

The vibration generated from the second integrated electromechanical unit 15 includes, for example, vibration generated by the rotation of the rear-wheel driving motor-generator MGR. The vibration generated from the second integrated electromechanical unit 15 includes, for example, vibration generated by driving of the differential device 91 which is a power transmission mechanism. The vibration generated from the second integrated electromechanical unit 15 includes, for example, vibration caused by unevenness of a road surface, which is transmitted via the rear wheel 26 and the drive shaft.

As shown in FIG. 3, a floor panel 101 is provided between the vehicle on-board charger 96 and the second integrated electromechanical unit 15. The vibration generated from the second integrated electromechanical unit 15 is attenuated by the floor panel 101 before reaching the vehicle on-board charger 96.

### Advantages of the Present Embodiment

(1) The above-described mounting structure for the vehicle on-board device can reduce the influence of the vibration generated from the second integrated electromechanical unit 15 on the vehicle on-board charger 96.

(2) As shown in FIG. 2, the electric vehicle 10 includes the radiator 60. The radiator 60 cools the coolant. The coolant recovers heat generated from the vehicle on-board charger 96 and heat generated from the second integrated electromechanical unit 15. The electric vehicle 10 includes a first cooling pipe 61, a second cooling pipe 62, and a third cooling pipe 63 as cooling pipes through which the coolant flows.

As shown in FIG. 3, the vehicle on-board charger 96 includes a first water jacket 64 through which coolant flows. The second integrated electromechanical unit 15 includes a second water jacket 65 through which the coolant flows. The floor panel 101 has a first floor through-hole 102 and a second floor through-hole 103 as through-holes extending in the vehicle vertical direction. The second cooling pipe 62 connects the first water jacket 64 to the second water jacket 65. The second cooling pipe 62 is inserted through the second floor through-hole 103.

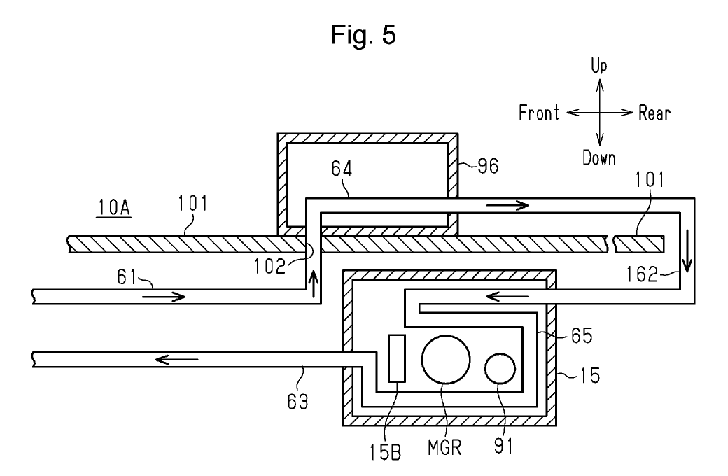

FIG. 5 is a schematic diagram showing how of cooling pipes of a comparative example are routed. Also in FIG. 5, the flow direction of the coolant is indicated by arrows. That is, the coolant flows through the radiator 60, the first cooling pipe 61, the first water jacket 64, a comparative second cooling pipe 162, the second water jacket 65, and the third cooling pipe 63 in this order.

The comparative second cooling pipe 162 shown in FIG. 5 is not inserted into any of the floor through-holes, which are provided in the floor panel 101 and extend in the vehicle vertical direction. In other words, the comparative second cooling pipe 162 does not extend through the floor panel 101. The comparative second cooling pipe 162 of FIG. 5 needs to be routed between the vehicle on-board charger 96 and the second integrated electromechanical unit 15 so as to bypass the floor panel 101.

If the second cooling pipe 62 is short, the weight of the second cooling pipe 62 is reduced. That is, the weight of the electric vehicle 10 is reduced. Therefore, the length of the second cooling pipe 62 is preferably short.

As shown in FIG. 3, the second cooling pipe 62 of the present embodiment is inserted into the second floor through-hole 103 extending in the vehicle vertical direction. The second cooling pipe 62 connects the first water jacket 64 to the second water jacket 65. That is, the second cooling pipe 62 is inserted into the second floor through-hole 103 provided in the floor panel 101. The second cooling pipe 62 shown in FIG. 3 is shorter than the comparative second cooling pipe 162 shown in FIG. 5, which is routed to bypass the floor panel 101. According to the vehicle on-board device mounting structure of the present embodiment, it is possible to shorten the second cooling pipe 62.

(3) As shown in FIG. 4, the vehicle on-board charger 96, the second floor through-hole 103, and the second integrated electromechanical unit 15 at least partially overlap each other when viewed in the vehicle vertical direction. The second cooling pipe 62 is inserted through the second floor through-hole 103. For example, when the vehicle on-board charger 96 and the second floor through-hole 103 do not overlap as viewed in the vehicle vertical direction, the second cooling pipe 62 needs to extend in the vehicle front-rear direction or the vehicle width direction in the space above the floor panel 101. For example, when the second floor through-hole 103 and the second integrated electromechanical unit 15 do not overlap each other as viewed in the vehicle vertical direction, the second cooling pipe 62 needs to extend in the vehicle front-rear direction or the vehicle width direction in the space below the floor panel 101. According to the mounting structure for the vehicle on-board device described above, the first water jacket 64 and the second water jacket 65 can be connected by the second cooling pipe 62 without extending the second cooling pipe 62 in the vehicle front-rear direction or the vehicle width direction. The above-described mounting structure for a vehicle on-board device, for example, allows the second cooling pipe 62 to be shorter than in a case in which the vehicle on-board charger 96, the second floor through-hole 103, and the second integrated electromechanical unit 15 do not overlap.

(4) As shown in FIG. 1, the engine 40, which is a power source of the electric vehicle 10, is disposed in the front compartment 10B. The front compartment 10B is located forward of the passenger compartment 10A in the vehicle. The passenger compartment 10A is separated from the front compartment 10B by a dashboard panel 100. Therefore, the vibration generated from the engine 40 disposed in the front compartment 10B is attenuated by the dashboard panel 100 before reaching the vehicle on-board charger 96 disposed in the passenger compartment 10A. The above-described mounting structure for the vehicle on-board device can reduce the influence of the vibration generated from the engine 40 and the second integrated electromechanical unit 15 on the vehicle on-board charger 96.

(5) As shown in FIG. 1, the electric vehicle 10 includes the front row seats 17 and the rear row seats 18. The front row seats 17 include a driver's seat. The front row seats 17 and the rear row seats 18 are disposed in the passenger compartment 10A. The vehicle on-board charger 96 is disposed rearward of the rear row seats 18. The front row seats 17 and the rear row seats 18 are disposed between the engine 40 disposed in the front compartment 10B and the vehicle on-board charger 96 disposed in the passenger compartment 10A. In the above-described mounting structure for a vehicle on-board device, the vehicle on-board charger 96 is disposed at a position farther from the engine 40, for example, than in a case in which the vehicle on-board charger 96 is disposed forward the rear row seats 18 in the vehicle. The above-described mounting structure for the vehicle on-board device can reduce the influence of the vibration generated from the engine 40 on the vehicle on-board charger 96.

### Modifications

The above-described embodiment may be modified as follows. The above-described embodiment and the following modifications of the above-described embodiment can be implemented in combination with each other to the extent that there is no technical contradiction.

In the above embodiment, the vehicle on-board charger 96 is disposed on the floor panel 101, and the second integrated electromechanical unit 15 is disposed under the floor panel 101. The floor panel 101 reduces the influence of the vibration generated from the second integrated electromechanical unit 15 on the vehicle on-board charger 96. The vehicle on-board charger 96, the second floor through-hole 103, and the second integrated electromechanical unit 15 do not necessarily need to overlap when viewed in the vehicle vertical direction. For example, the rear end of the vehicle on-board charger 96 may be positioned forward of the front end of the second floor through-hole 103. In other words, the vehicle on-board charger 96 may be positioned forward of the second floor through-hole 103 without overlapping with the second floor through-hole 103 in the vehicle vertical direction. For example, the left end of the vehicle on-board charger 96 may be located on the right of the right end of the second floor through-hole 103. For example, the front end of the second integrated electromechanical unit 15 may be positioned rearward of the rear end of the second floor through-hole 103. For example, the right end of the second integrated electromechanical unit 15 may be positioned further to the left than the left end of the second floor through-hole 103. For example, the rear end of the vehicle on-board charger 96 may be located forward of the front end of the second integrated electromechanical unit 15. For example, the left end of the vehicle on-board charger 96 may be positioned on the right side of the right end of the second integrated electromechanical unit 15.

If the vehicle on-board charger 96 is disposed on the floor panel 101 and the second integrated electromechanical unit 15 is disposed under the floor panel 101, the floor panel 101 does not necessarily need to have a through-hole.

The vehicle on-board charger 96 and the second integrated electromechanical unit 15 does not necessarily need to be connected by the second cooling pipe 62. In other words, the vehicle on-board charger 96 and the second integrated electromechanical unit 15 may be configured to be cooled by coolant flowing through cooling pipes independent of each other.

The electric vehicle 10 may be an electric automobile on which the engine 40 is not mounted. Even in such a case, according to the above-described mounting structure for the vehicle on-board device, the vehicle on-board charger 96 is protected from vibration generated by the second integrated electromechanical unit 15 disposed under the floor panel 101.

If the vehicle on-board charger 96 is disposed above the floor panel 101, the vehicle on-board charger 96 may be disposed forward of the rear row of seats 18. If the vehicle on-board charger 96 is disposed above the floor panel 101, the vehicle on-board charger 96 may be disposed forward of the front row seats 17.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A mounting structure for a vehicle on-board device, the mounting structure comprising:
a floor panel that forms a floor surface of a passenger compartment of an electric vehicle;
an integrated electromechanical unit as a vehicle on-board device mounted on the electric vehicle; and
a vehicle on-board charger that charges a battery cell of the electric vehicle by converting AC power supplied from outside into DC power, wherein
the integrated electromechanical unit includes:
a motor that is a power source of the electric vehicle; and
a power transmission mechanism that transmits a driving force of the motor to a drive wheel of the electric vehicle,
the vehicle on-board charger is disposed above the floor panel, and
the integrated electromechanical unit is disposed under the floor panel.

2. The mounting structure for a vehicle on-board device according to claim 1, wherein
the electric vehicle includes:
a radiator that cools coolant, the coolant recovering heat generated in the vehicle on-board charger and the integrated electromechanical unit; and
a cooling pipe through which the coolant flows,
the vehicle on-board charger includes a first water jacket through which the coolant flows,
the integrated electromechanical unit includes a second water jacket through which the coolant flows,
the floor panel includes a floor through-hole as a through-hole extending in a vehicle vertical direction,
the cooling pipe connects the first water jacket to the second water jacket, and
the cooling pipe is inserted through the floor through-hole.

3. The mounting structure for a vehicle on-board device according to claim 2, wherein the vehicle on-board charger, the floor through-hole, and the integrated electromechanical unit are disposed so as to at least partially overlap when viewed in the vehicle vertical direction.

4. The mounting structure for a vehicle on-board device according to claim 1, wherein
the electric vehicle includes:
a front compartment located forward of the passenger compartment;
a dashboard panel that separates the passenger compartment from the front compartment; and
an engine as another power source of the electric vehicle, and
the engine is disposed in the front compartment.

5. The mounting structure for a vehicle on-board device according to claim 4, wherein
the electric vehicle includes a seat, the seat including a driver’s seat,
the seat is disposed in the passenger compartment, and
the vehicle on-board charger is disposed rearward of the seat.
